(19) United States
(12) Patent Application Publication
(10) Pub. No.: US 2024/0236878 A1
(43) Pub. Date: Jul. 11, 2024

(54) METHOD AND APPARATUS COMMUNICATION IN COOPERATIVE WIRELESS COMMUNICATION SYSTEMS

(71) Applicant: Samsung Electronics Co., Ltd., Gyeonggi-do (KR)

(72) Inventors: Ameha Tsegaye ABEBE, Gyeonggi-do (KR); Hyoungju JI, Gyeonggi-do (KR); Younsun KIM, Gyeonggi-do (KR); Youngrok JANG, Gyeonggi-do (KR)

(21) Appl. No.: 18/559,709

(22) PCT Filed: May 24, 2022
(86) PCT No.: PCT/KR2022/007364

§ 371 Date: Nov. 8, 2023

(30) Foreign Application Priority Data
May 24, 2021 (KR) 10-2021-0066270
Apr. 18, 2022 (KR) 10-2022-0047528

(51) Int. Cl. H04W 52/40; H04W 52/14; H04W 52/26

(52) U.S. Cl. CPC H04W 52/40; H04W 52/146; H04W 52/265

(57) ABSTRACT

The disclosure relates to a 5G or 6G communication system for supporting a higher data transmission rate. The disclosure includes a methods and apparatus to enable massive and low-latency access via distributed massive MIMO where downlink reference signal or downlink synchronization signal is utilized for an open-loop power control designed to be suitable for compressive sensing-based grant free-random access.

### TECHNICAL FIELD

The present disclosure relates to the field of 5G communication networks and communication networks beyond the 5G such us 6G and more particularly to hybrid Fresnel and Frauenhoffer zone beamforming in Indoor millilmeter-Wave Bases station. In another aspect, the present disclosure is also related to supporting massive and low-latency access via distributed massive MIMO system.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

The above information is presented as background information only to assist with an understanding of the disclosure. No determination has been made, and no assertion is made, as to whether any of the above might be applicable as prior art with regard to the disclosure.

### DISCLOSURE OF INVENTION

### Technical Problem

Aspects of the disclosure are to address at least the above-mentioned problems and/or disadvantages and to provide at least the advantages described below. Accordingly, an aspect of the disclosure is to disclose methods and apparatus for hybrid Fresnel and Frauenhoffer zone beamforming in indoor millilmeter-Wave bases station in a communication network, wherein the communication network is at least one of the Fifth Generation (5G) standalone network and a 5G non-standalone (NAS) network.

Another aspect of the disclosure is to disclose methods and systems for a method to operate both Fresnel and Frauenhoffer zone beamforming by making a larger aperture without increasing the antenna element in the millimeter wave band.

Another aspect of the disclosure is to disclose a methods and apparatus to enable massive and low-latency access via distributed massive MIMO (MAD) where downlink reference (synchronization) signal is utilized for an open-loop power control designed to be suitable for CS-based GF-RA.

Another object of the disclosure herein is to propose a novel active-user detection (AUD) scheme which exploits the adjacency information of TRPs in MAD system is proposed.

### Solution to Problem

Additional aspects will be set forth in part in the description which follows and, in part, will be apparent from the description, or may be learned by practice of the presented embodiments.

In accordance with an aspect of the present disclosure, a method performed by a terminal in a communication system is provided. The method includes receiving a plurality of signals from a plurality of transmission and reception points (TRPs), respectively, obtaining each of a plurality of channel gains corresponding to each of the TRPs based on the received plurality of signals, obtaining a parameter for identifying an uplink transmission power, identifying the uplink transmission power for a TRP among the plurality of TRPs based on the parameter and a channel gain associated with the TRP, and transmitting an uplink signal based on the identified uplink transmission power.

In accordance with another aspect of the present disclosure, a method performed by a base station in a communication system is provided, the method includes transmitting, to a terminal, a plurality of signals corresponding to a plurality of transmission and reception points (TRPs), respectively, transmitting, to the terminal, a parameter for identifying an uplink transmission power via system information block (SIB), and receiving, from the terminal, an uplink signal for a TRP, wherein the uplink signal is transmitted according to the uplink transmission power for the TRP associated with the parameter and a channel gain associated with the TRP.

In accordance with another aspect of the present disclosure, a terminal in a communication system is provided. The terminal base station includes a transceiver and a controller coupled with the transceiver and configured to receive a plurality of signals from a plurality of transmission and reception points (TRPs), respectively, obtain each of a plurality of channel gains corresponding to each of the TRPs based on the received plurality of signals, obtain a parameter for identifying an uplink transmission power, identify the uplink transmission power for a TRP among the plurality of TRPs based on the parameter and a channel gain associated with the TRP, and transmit an uplink signal based on the identified uplink transmission power.

In accordance with another aspect of the present disclosure, a base station in a communication system is provided. The base station includes a transceiver and a controller coupled with the transceiver and configured to transmit, to a terminal, a plurality of signals corresponding to a plurality of transmission and reception points (TRPs), respectively, transmit, to the terminal, a parameter for identifying an uplink transmission power via system information block (SIB), and receive, from the terminal, an uplink signal for a TRP, wherein the uplink signal is transmitted according to the uplink transmission power for the TRP associated with the parameter and a channel gain associated with the TRP.

### Advantageous Effects of Invention

Through the proposed method, the Fresnel zone can be maximized in an indoor line-of-sight environment, and the signal strength can be improved by selectively using a beamforming method according to the user's location.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

Embodiments herein are illustrated in the accompanying drawings, throughout which like reference letters indicate corresponding parts in the various figures. The embodiments herein will be better understood from the following description with reference to the drawings, in which:

FIG. 1 illustrates one example of a wireless network.

FIG. 2a illustrates an example of wireless transmit path according to an embodiment of the disclosure.

FIG. 2b illustrates an example of wireless receive path according to an embodiment of the disclosure.

FIG. 3a illustrates an example UE 116 according to an embodiment of the disclosure.

FIG. 3b illustrates an example gNB 102 according to an embodiment of the disclosure.

FIG. 4 illustrates an example of mapping of a synchronization signal (SS) and a physical broadcasting channel (PBCH) in the frequency and time domain of an embodiment of the disclosure.

FIG. 5 illustrates an example of symbols in which the SS/PBCH block can be transmitted according to subcarrier spacing in an embodiment of the disclosure.

FIG. 6a illustrates an example of co-located mMIMO system and an example of distributed mMIMO system.

FIG. 6b illustrates mis-detection rate vs Noise power for co-located and distributed mMIMO with M=20, N=4, L=40.

FIG. 7 illustrates an exemplary embodiment of the disclosure.

FIG. 8 illustrates an exemplary embodiment for a transmission structure according to the disclosure.

FIG. 9 illustrates another exemplary embodiment of co-located mMIMO system and distributed mMIMO system according to the disclosure.

FIG. 10 illustrates the signaling between the network and a UE according to an embodiment of the disclosure.

FIG. 11 illustrates a procedure of the UE according to an embodiment of the disclosure.

FIG. 12 illustrates an example of electromagnetic field in the vicinity of an antenna.

FIG. 13 illustrates an example of phase array antennas.

FIG. 14 illustrates the signal strength of proposed scheme for various angle (θᵣ=0°, −30°, −45°, −75°) and distance (dᵣ=1.5 m) according to the disclosure.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements. Further, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing communication functions. In the disclosure, a “downlink (DL)” refers to a radio link via which a base station transmits a signal to a terminal, and an “uplink (UL)” refers to a radio link via which a terminal transmits a signal to a base station. Further, in the following description, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, or other similar services. In addition, based on determinations by those skilled in the art, the embodiments of the disclosure may also be applied to other communication systems through some modifications without significantly departing from the scope of the disclosure.

Herein, it will be understood that each block of the flowchart illustrations, and combinations of blocks in the flowchart illustrations, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that may direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Further, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more CPUs within a device or a security multimedia card. Further, the “unit” in the embodiments may include one or more processors.

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

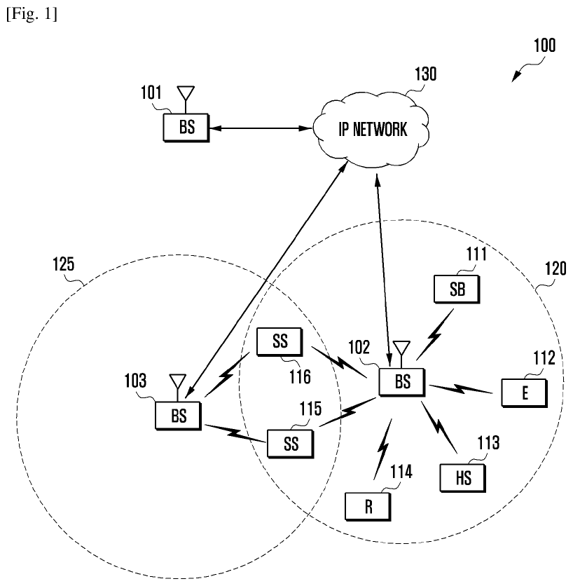

FIG. 1 illustrates an example wireless network 100 according to this disclosure. The embodiment of the wireless network 100 shown in FIG. 1 is for illustration only. Other embodiments of the wireless network 100 can be used without departing from the scope of this disclosure.

The wireless network 100 includes an gNodeB (gNB) 101, an gNB 102, and an gNB 103. The gNB 101 communicates with the gNB 102 and the gNB 103. The gNB 101 also communicates with at least one Internet Protocol (IP) network 130, such as the Internet, a proprietary IP network, or other data network.

Depending on the network type, the term ‘gNB’ can refer to any component (or collection of components) configured to provide remote terminals with wireless access to a network, such as base transceiver station, a radio base station, transmit point (TP), transmit-receive point (TRP), a ground gateway, an airborne gNB, a satellite system, mobile base station, a macrocell, a femtocell, a WiFi access point (AP) and the like. Also, depending on the network type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used in this patent document to refer to equipment that wirelessly accesses a gNB. The UE could be a mobile device or a stationary device. For example, UE could be a mobile telephone, smartphone, monitoring device, alarm device, fleet management device, asset tracking device, automobile, desktop computer, entertainment device, infotainment device, vending machine, electricity meter, water meter, gas meter, security device, sensor device, appliance etc

The gNB 102 provides wireless broadband access to the network 130 for a first plurality of user equipments (UEs) within a coverage area 120 of the gNB 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G, long-term evolution (LTE), LTE-A, WiMAX, or other advanced wireless communication techniques.

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of BS 101, BS 102 and BS 103 include 2D antenna arrays as described in embodiments of the present disclosure. In some embodiments, one or more of BS 101, BS 102 and BS 103 support the codebook design and structure for systems having 2D antenna arrays.

Although FIG. 1 illustrates one example of a wireless network 100, various changes may be made to FIG. 1. For example, the wireless network 100 can include any number of gNBs and any number of UEs in any suitable arrangement. Also, the gNB 101 can communicate directly with any number of UEs and provide those UEs with wireless broadband access to the network 130. Similarly, each gNB 102-103 can communicate directly with the network 130 and provide UEs with direct wireless broadband access to the network 130. Further, the gNB 101, 102, and/or 103 can provide access to other or additional external networks, such as external telephone networks or other types of data networks.

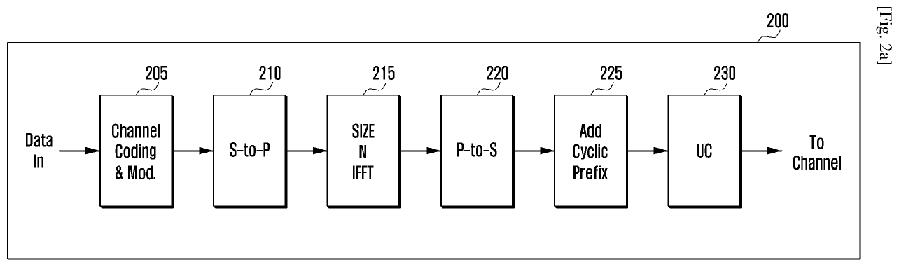

FIG. 2a illustrates an example of wireless transmit path according to an embodiment of the disclosure and FIG. 2b illustrates an example of wireless receive path according to an embodiment of the disclosure. In the following description, a transmit path 200 may be described as being implemented in an gNB (such as gNB 102), while a receive path 250 may be described as being implemented in a UE (such as UE 116). However, it will be understood that the receive path 250 can be implemented in an gNB and that the transmit path 200 can be implemented in a UE. In some embodiments, the receive path 250 is configured to support the codebook design and structure for systems having 2D antenna arrays as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an upconverter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2a and 2b can be implemented using only hardware or using a combination of hardware and software/firmware. As a particular example, at least some of the components in FIGS. 2a and 2b may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2a and 2b illustrate examples of wireless transmit and receive paths, various changes may be made to FIGS. 2a and 2b. For example, various components in FIGS. 2A and 2B can be combined, further subdivided, or omitted and additional components can be added according to particular needs. Also, FIGS. 2a and 2b are meant to illustrate examples of the types of transmit and receive paths that can be used in a wireless network. Any other suitable architectures can be used to support wireless communications in a wireless network.

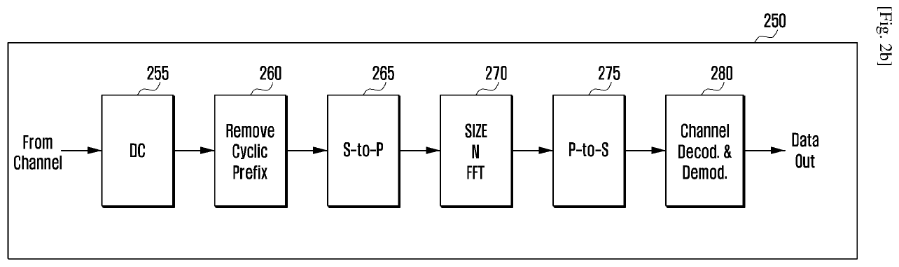

FIG. 3a illustrates an example UE 116 according to an embodiment of the disclosure. The embodiment of the UE 116 illustrated in FIG. 3a is for illustration only, and the UEs 111-115 of FIG. 1 can have the same or similar configuration. However, UEs come in a wide variety of configurations, and FIG. 3a does not limit the scope of this disclosure to any particular implementation of a UE.

The UE 116 includes an antenna 305, a radio frequency (RF) transceiver 310, transmit (TX) processing circuitry 315, a microphone 320, and receive (RX) processing circuitry 325. The UE 116 also includes a speaker 330, a main processor 340, an input/output (I/O) interface (IF) 345, a keypad 350, a display 355, and a memory 360. The memory 360 includes a basic operating system (OS) program 361 and one or more applications 362.

The RF transceiver 310 receives, from the antenna 305, an incoming RF signal transmitted by an gNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the main processor 340 for further processing (such as for web browsing data).

The TX processing circuitry 315 receives analog or digital voice data from the microphone 320 or other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The main processor 340 can include one or more processors or other processing devices and execute the basic OS program 361 stored in the memory 360 in order to control the overall operation of the UE 116. For example, the main processor 340 can control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller.

The main processor 340 is also capable of executing other processes and programs resident in the memory 360, such as operations for channel quality measurement and reporting for systems having 2D antenna arrays as described in embodiments of the present disclosure as described in embodiments of the present disclosure. The main processor 340 can move data into or out of the memory 360 as required by an executing process. In some embodiments, the main processor 340 is configured to execute the applications 362 based on the OS program 361 or in response to signals received from gNBs or an operator. The main processor 340 is also coupled to the I/O interface 345, which provides the UE 116 with the ability to connect to other devices such as laptop computers and handheld computers. The I/O interface 345 is the communication path between these accessories and the main controller 340.

The main processor 340 is also coupled to the keypad 350 and the display unit 355. The operator of the UE 116 can use the keypad 350 to enter data into the UE 116. The display 355 may be a liquid crystal display or other display capable of rendering text and/or at least limited graphics, such as from web sites. The memory 360 is coupled to the main processor 340. Part of the memory 360 can include a random access memory (RAM), and another part of the memory 360 can include a Flash memory or other read-only memory (ROM).

Although FIG. 3a illustrates one example of UE 116, various changes may be made to FIG. 3a. For example, various components in FIG. 3a can be combined, further subdivided, or omitted and additional components can be added according to particular needs. As a particular example, the main processor 340 can be divided into multiple processors, such as one or more central processing units (CPUs) and one or more graphics processing units (GPUs). Also, while FIG. 3a illustrates the UE 116 configured as a mobile telephone or smartphone, UEs can be configured to operate as other types of mobile or stationary devices.

FIG. 3b illustrates an example gNB 102 according to an embodiment of the disclosure. The embodiment of the gNB 102 shown in FIG. 3b is for illustration only, and other gNBs of FIG. 1 can have the same or similar configuration. However, gNBs come in a wide variety of configurations, and FIG. 3b does not limit the scope of this disclosure to any particular implementation of an gNB. It is noted that gNB 101 and gNB 103 can include the same or similar structure as gNB 102.

As shown in FIG. 3b, the gNB 102 includes multiple antennas 370a-370n, multiple RF transceivers 372a-372n, transmit (TX) processing circuitry 374, and receive (RX) processing circuitry 376. In certain embodiments, one or more of the multiple antennas 370a-370n include 2D antenna arrays. The gNB 102 also includes a controller/processor 378, a memory 380, and a backhaul or network interface 382.

The RF transceivers 372a-372n receive, from the antennas 370a-370n, incoming RF signals, such as signals transmitted by UEs or other gNBs. The RF transceivers 372a-372n down-convert the incoming RF signals to generate IF or baseband signals. The IF or baseband signals are sent to the RX processing circuitry 376, which generates processed baseband signals by filtering, decoding, and/or digitizing the baseband or IF signals. The RX processing circuitry 376 transmits the processed baseband signals to the controller/processor 378 for further processing.

The TX processing circuitry 374 receives analog or digital data (such as voice data, web data, e-mail, or interactive video game data) from the controller/processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-converts the baseband or IF signals to RF signals that are transmitted via the antennas 370a-370n.

The controller/processor 378 can include one or more processors or other processing devices that control the overall operation of the gNB 102. For example, the controller/processor 378 can control the reception of forward channel signals and the transmission of reverse channel signals by the RF transceivers 372a-372n, the RX processing circuitry 376, and the TX processing circuitry 374 in accordance with well-known principles. The controller/processor 378 can support additional functions as well, such as more advanced wireless communication functions. For instance, the controller/processor 378 can perform the blind interference sensing (BIS) process, such as performed by a BIS algorithm, and decodes the received signal subtracted by the interfering signals. Any of a wide variety of other functions can be supported in the gNB 102 by the controller/processor 378. In some embodiments, the controller/processor 378 includes at least one microprocessor or microcontroller.

The controller/processor 378 is also capable of executing programs and other processes resident in the memory 380, such as a basic OS. The controller/processor 378 is also capable of supporting channel quality measurement and reporting for systems having 2D antenna arrays as described in embodiments of the present disclosure. In some embodiments, the controller/processor 378 supports communications between entities, such as web RTC. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 can support communications over any suitable wired or wireless connection(s). For example, when the gNB 102 is implemented as part of a cellular communication system (such as one supporting 5G, LTE, or LTE-A), the interface 382 can allow the gNB 102 to communicate with other gNBs over a wired or wireless backhaul connection. When the gNB 102 is implemented as an access point, the interface 382 can allow the gNB 102 to communicate over a wired or wireless local area network or over a wired or wireless connection to a larger network (such as the Internet). The interface 382 includes any suitable structure supporting communications over a wired or wireless connection, such as an Ethernet or RF transceiver.

The memory 380 is coupled to the controller/processor 378. Part of the memory 380 can include a RAM, and another part of the memory 380 can include a Flash memory or other ROM. In certain embodiments, a plurality of instructions, such as a BIS algorithm is stored in memory. The plurality of instructions are configured to cause the controller/processor 378 to perform the BIS process and to decode a received signal after subtracting out at least one interfering signal determined by the BIS algorithm.

As described in more detail below, the transmit and receive paths of the gNB 102 (implemented using the RF transceivers 372a-372n, TX processing circuitry 374, and/or RX processing circuitry 376) support communication with aggregation of FDD cells and TDD cells.

Although FIG. 3b illustrates one example of an gNB 102, various changes may be made to FIG. 3b. For example, the gNB 102 can include any number of each component shown in FIG. 3b. As a particular example, an access point can include a number of interfaces 382, and the controller/processor 378 can support routing functions to route data between different network addresses. As another particular example, while shown as including a single instance of TX processing circuitry 374 and a single instance of RX processing circuitry 376, the gNB 102 can include multiple instances of each (such as one per RF transceiver).

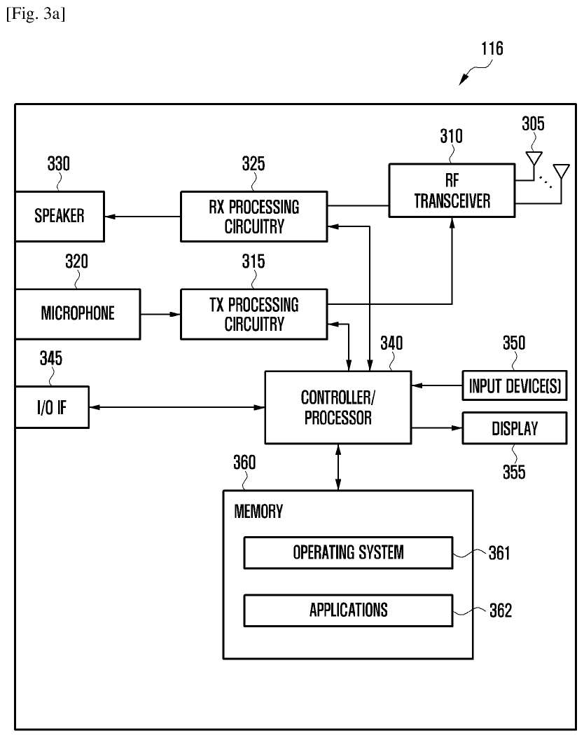

FIG. 4 illustrates an example of mapping of a synchronization signal (SS) and a physical broadcasting channel (PBCH) in the frequency and time domain of an embodiment of the disclosure.

A primary synchronization signal (PSS) 401, a secondary synchronization signal (SSS) 403, and a PBCH 405 are mapped over 4 orthogonal frequency-division multiplexing (OFDM) symbols, and the PSS and the SSS are mapped to 12 resource blocks (RBs) and the PBCH is mapped to 20 RBs. A table in FIG. 4 shows how a frequency band of 20 RBs is changed according to subcarrier spacing (SCS). A resource area in which the PSS, the SSS, and the PBCH are transmitted may be called an SS/PBCH block. Further, the SS/PBCH block may be referred to as an SSB block.

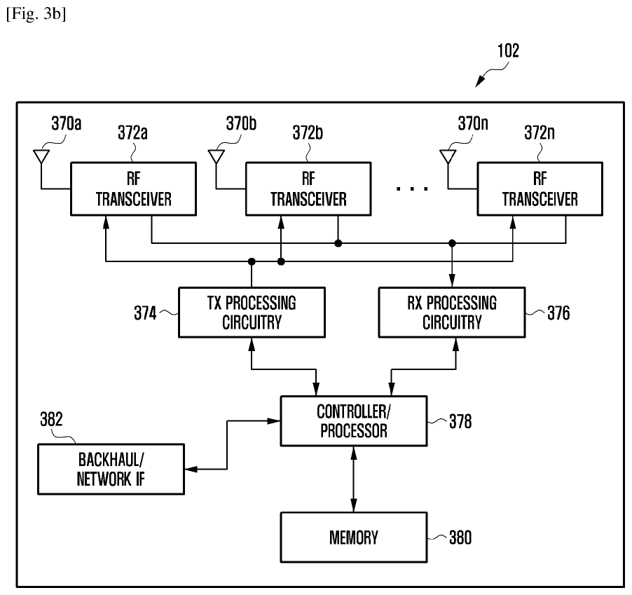

FIG. 5 illustrates an example of symbols in which the SS/PBCH block can be transmitted according to subcarrier spacing in an embodiment of the disclosure. Referring to FIG. 3, subcarrier spacing may be configured as 15 kHz, 30 kHz, 120 kHz, 240 kHz, and the like, and the location of a symbol in which the SS/PBCH block can be positioned may be determined according to each subcarrier spacing. FIG. 5 illustrates the location of symbols in which the SSB can be transmitted according to subcarrier spacing in symbols within 1 ms, and the SSB is not always transmitted in an area illustrated in FIG. 5. The location in which the SSB block is transmitted may be configured in the UE through system information or dedicated signaling.

Wireless communication is constantly shifting its direction to higher frequencies with wider bandwidth to support ultra-high date rates. In particular, 5G communication system uses a millimeter wave (mmWave) band with 400 MHZ bandwidth and is expected to use Terahertz spectrum at 6G. When the frequency band is increased, the wavelength becomes short and thus the size and dimension of antenna would be small. To make the required size antenna aperture, a large number of antennas can be packed and the complexity and cost of hardware to operate a large number of antenna elements will become high.

The large antenna aperture can have two advantages. One is to increase the antenna gain and the other is to expend the Fresnel Zone. When the antenna gain becomes large, the signal is transmitted to the longer distance to improve the cell coverage. When the Fresnel zone is wider, signal strength can be improved by focusing the radio-wave as if the light is focused using the convex lens or dish antennas in satellite communications. However, it is difficult to use the larger aperture in a phased array structure, this is typically used in mmWave, due to the large number of antenna elements required and the complexity to operate them. In this paper, we propose a method to operate both Fresnel and Frauenhoffer zone by making a larger aperture without increasing the antenna element in the mmWave indoor coverage.

### <Power Control in Grant-Free Random Access>

Grant-free random access (GF-RA) wherein a user (or user equipment) transmits a data accompanied by a transmission-identifying preamble in a single shot, without waiting for collision resolution and resource grant from the base station (BS), is considered as an enabler of massive & low latency access (mLLA) for systems beyond the 5G (B5G). The preamble in the GF-RA is used to identify the transmission for what is widely known as active user detection (AUD), channel estimation and uplink synchronization. Recent studies on mLLA enabling GF-RA consider either a user to be assigned with or randomly select a preamble from a large pool of non-orthogonal preambles. While the first class avoids collision in random access selection, it is not as scalable as the second class in supporting a large number of users, e.g., 107 devices per km². Herein, the term non-orthogonality simply mean the number of preambles (Nₚ) is much larger than the length of the preamble (L), wherein the ratio (γ≙Nₚ/L>>1) can be considered as the scaling factor of GF-RA. We note that for special sequences such as Zadoff-Chu and Gold sequences, the term non-orthogonality can also be interpreted as a non-zero cross correlation among the preambles. Then, exploiting a sparse selection of preambles, i.e., only a small subset of preambles from the pool are active at GF-RA occasion, the concept of Compressive-sensing (CS) can be employed for AUD at the receiver.

Once the active preambles are correctly detected, the remaining channel and data symbols estimation can simply be treated as a conventional multi-user detection (MUD) problem, hence, traditional estimation techniques such as minimum mean square error estimation (MMSE) may be employed. If K preambles are active at a GF-RA occasion, where K<<Nₚ, a resource utilization factor can be defined as

$$n {=}^{Δ} \frac{K}{L} .$$

Therefore, the main design goal in GF-RA for mLLA evolves around supporting a high scaling factor (γ) and utilization factor (η) while ensuring reliable AUD.

The availability of multiple antennas at the BS in a massive MIMO (mMIMO) system, allows the CS-based AUD to be modeled as multiple measurement-vector (MMV) problem. When the number of antenna ports scale up with the number of active preambles (users) and under ideal conditions, mMIMO-based GF-RA may achieve η≈1, while deriving the activity misdetection rate to zero. However, one of the stringent requirements among the ideal conditions is the requirement for perfect power control in which the signals power received from users should be ‘perfectly balanced’. This requirement is very limiting in the traditional co-located mMIMO system where users' signal-to-noise ratio (SNR) is sacrificed in order to accommodate cell-edge users ultimately degrading the AUD performance.

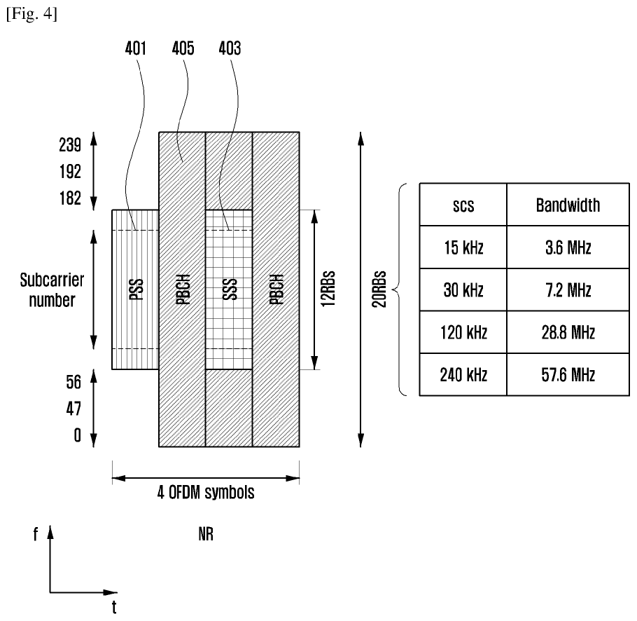

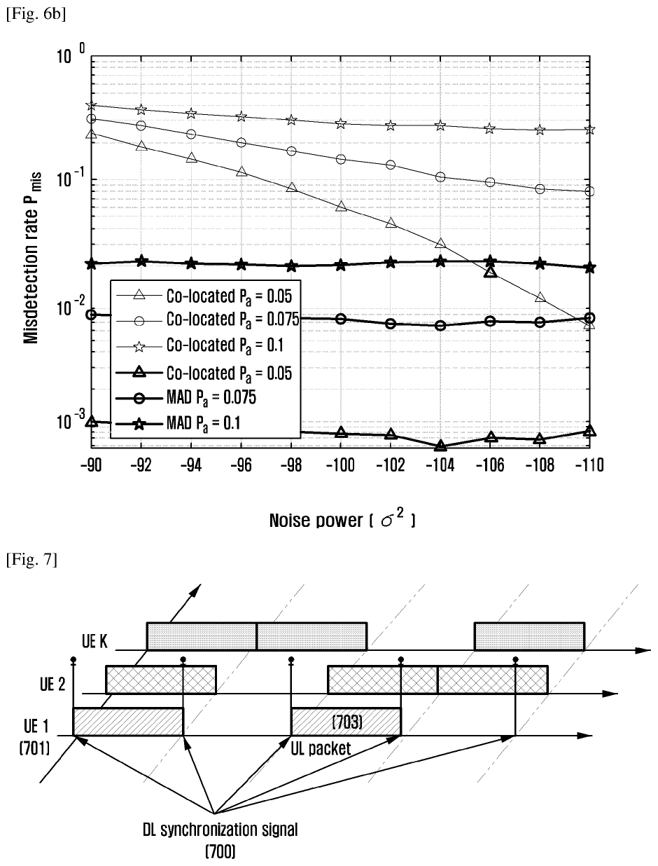

FIG. 6 illustrates an example of co-located mMIMO system and an example of distributed mMIMO system. Referring to FIG. 6, (a) (600) illustrates an example of co-located mMIMO system and (b) (610) illustrates an example of distributed mMIMO system. In the collocated antenna system (600), antenna ports which are physically located in close proximity transmit and receive to/from devices in the coverage area. On the other hand, an equivalent system with distributed antenna ports (610) consist of a group of antenna ports which where the group antenna ports which can be referred as remote radio head (RRH) are physically distributed over coverage area. A detail description of (600) and (610) is given in FIG. 9.

Consider a time-division duplexing (TDD)-based cell-free massive MIMO system wherein M TRPs each equipped with N antennas serve N_{UE} UEs depicted in FIG. 1. For a narrowband system, the channel between the k-th UE and the n-th antenna of m-th TRP is given as Equation 1 below.

$${g}_{mnk} = {β}_{mk}^{1 / 2} {h}_{mnk} \qquad [ Equation 1 ]$$

where βₘₖ^{1/2} is the large scale channel coefficient between m-th TRP and k-th UE and hₘₙₖ˜ [symbol] (0,1) is small scale channel fading. Then the received signal at n-th antenna of m-th TRP, yₘₙ, is given as Equation 2.

$${y}_{mn} = {\sum }_{k = 1}^{{N}_{UE}} {α}_{k} \sqrt{{ρ}_{k}} {p}_{k} {g}_{mnk} + {ω}_{mn} = {Pg}_{mn} + {ω}_{mn} \qquad [ Equation 2 ]$$

where αₖ∈{0,1} is an activity indicator which assumes the value 1 with low probability, if the k-th user is active and αₖ∈{0,1} is a noise vector with power σ² where I_{L} denotes L×L identity matrix. Moreover, pₖ∈ [symbol] ^{L×1} is L-length complex preamble sequence while ρₖ is the transmission power employed by k-th user. Moreover, P=[p₁p₂ . . . p_{N}_{ₚ}] assuming preambles are one-to-one assigned to UEs, i.e., N_{UE}=Nₚ. The case wherein a user randomly select a preamble is discussed separately in subsequent section. Furthermore, the sparse vector gₘₙ is given as gₘₙ=[\tilde{g}ₘₙ₁ \tilde{g}ₘₙ₂ . . . \tilde{g}_{mnN}_{ₚ}]^{T} where

$${\tilde{g}}_{mnk} = {α}_{k} \sqrt{{ρ}_{k}} {g}_{mnk} .$$

received preambles from each antenna of each TRP, i.e., {yₘₙ}_{m,n=1}^{M,N}, as Y[y₁₁y₁₂ . . . y_{MN}], then

$$Y = PG + Ω \qquad [ Equation 3 ]$$

where, G=[g₁₁g₁₂ . . . g_{MN}] and Ω=[ω₁₁ω₁₂ . . . ω_{MN}]

### <CS-Based Active User Detection (AUD) and Limitations of Existing Schemes>

In this section, we show that received signal model in Equation 2 and 3 are single and multiple measurement vector, i.e., SMV- and MMV-based, compressive sensing (CS) problems. Then, we show, the features of distributed mMIMO as compared to colocated mMIMO that enable GF-RA for mLAA. Let Λₘₙ denote a set that holds the index of nonzero elements of gₘₙ which is known as support set in CS lexicon, then, its cardinality, |Λₘₙ|≤K for the number of active users K. As few users are active at a GF-RA occasion, K<<N_{UE}. Moreover, the vectors, {gₘₙ}_{m,n=1}^{M,1} in Equation 3, share the same support, i.e., Λ=Λ₁₁=Λ₁₂= . . . =Λ_{MN} allowing it to be molded as an MMV problem.

Now, we notice that Equation 3 holds for an equivalent co-located mMIMO system with M×N antennas. In this case, the channel matrix can be decomposed as

$$G = \sum H$$

where

$$\sum = diag ( {[ {σ}_{1} {σ}_{2} … {σ}_{{N}_{UE}} ]}^{T} )$$

is a diagonal matrix with k-th diagonal element

$${σ}_{k} = {α}_{k} \sqrt{{ρ}_{k}} {β}_{k}^{1 / 2}$$

where σₖ² to receive power from k-th UE and βₖ^{1/2} is the large scale coefficient. Moreover, H∈ [symbol] ^{N}^{_{UE}}^{×MN} is a Gaussian matrix corresponding to small scale channel gain.

Given the signal model in Equation 3, the key operation in GF-RA is active user detection (AUD), i.e., correctly estimating the support Λ, then synchronization and channel estimation can be performed based on subset of preambles indexed by the detected support. As this support detection problem is a combinatorial non-convex problem, the AUD relay on greedy algorithms. In order to understand the relationship between system parameters, let us consider the upper bound on the probability of failing to recover at least one of the preambles(Pₘᵢₛ) with one of widely used greedy CS algorithm simultaneous orthogonal matching pursuit (SOMP).

$${P}_{mis} \leq {K}_{1} {2}^{\vert Λ \vert} exp ( \frac{- {K}_{2} MN}{\begin{matrix}min \\ k ∈ Λ\end{matrix} {σ}_{k}} ) \qquad [ Equation 4 ]$$

where K₁ and K₂ are constants which are function of SNR and can be referred in Theorem 8 of [18]. Note that the relation in Equation 4 holds to vast majority of greedy CS algorithms. The key takeaways from Equation 4 for mMIMO-based GF-RA is that Pₘᵢₛ decreases exponentially with the number of antenna elements (MN) while exponentially increasing with the number of active users |Λ| and the inverse of minimum power received at the BS

$$\begin{matrix}min \\ k ∈ Λ\end{matrix} {σ}_{k} .$$

In conventional art, an open loop power control is performed to meet a target received power σ_{trg}². As the there is a very large channel gain discrepancy among users in co-located mMIMO, however, such open loop power control either exclude some users or disproportionately degrade SNR. In the following we discuss how this relation can be exploited in the proposed massive access via distributed mMIMO (MAD).

Inspired by the relationship between the AUD performance and system parameters in Equation 4, we propose a massive access via distributed mMIMO (MAD) system where a UE estimates the large scale channel gain for each TRP based on downlink reference signals and performs power control to the P-th strongest TRP. Then an AUD scheme is performed which is aware of the proposed power-control scheme and the spatial arrangement of TRPs in distributed mMIMO.

An active UE first estimates the largescale channel gains {\hat{β}ₘₖ}ₘ₌₁^{M} from synchronously transmitted downlink reference signals. The DL reference signal could primary and secondary synchronization signals (PSS) and (SSS) in synchronization signal block (SSB). Let β″ₖ denote the P-th largest \hat{β}ₘₖ, then a UE adjust its power to meet a certain target receive power σ_{trg}² for the P-th strongest TRP as Equation 5.

$${ρ}_{k} = \{ \begin{matrix}{σ}_{trg}^{2} / {β}_{k}^{*} & if {β}_{k}^{*} \geq {σ}_{trg}^{2} / {ρ}_{max} \\ {ρ}_{max} & otherwise\end{matrix} \qquad [ Equation 5 ]$$

The parameter P can be adjusted by the network based on traffic load and be broadcasted along the SSB. The power control based on Equation 5 has advantage of two folds. First, it ensures a received power greater than σ_{trg}² for P TRPs as long as β″ₖ≥σ_{trg}²/ρₘₐₓ. This implies the users signal P×N compressed measurements with the required power. Secondly, if the residual threshold for a greedy algorithm (rₜₕ) is set as σ_{trg}², a user's transmission is excluded in the AUD process of TRPs with βₘₖ<β″ₖ, and hence, the perceived sparsity at each TRP increases. In particular, for m-th TRP the perceived size of support, i.e., Λₘ=Λₘ₁=Λₘ₂= . . . =Λ_{mN}, has a cardinality much lower than the number of active users, i.e., |Λₘ|<|Λ|≤K improving Pₘᵢₛ in Equation 4.

The activity estimates from greedy algorithms such as SOMP on each TRP can be combined and reiterated, based on a weighting factors defined from an adjacency graph matrix with its diagonal element is set to one and given as the ((m,m′)-th element w_{m,m′} can be used to weight the reliability of the detected support set from m′-th TRP at m-th TRP and can be defined as a function of the distance (d_{mm′}) between the two TRPs, i.e., w_{m,m′}=f(d_{mm′}). Moreover, as in the proposed MAD system, UE's transmission is targeted to P-th strongest TRP, the propagation delay to TRPs within is controlled and a large pool of non-orthogonal preambles with shorter cyclic shift sizes.

A cell-free massive MIMO system with M TRPs each equipped with N antennas are uniformly distributed over a 1 km² area is considered. An equivalent co-located mMIMO system with MN antennas and located at center of coverage area is considered. N_{UE}=400 which are uniformly distributed over the coverage area where each user is activated with activity probability P=0.05:0.1. Moreover, a three-slop propagation model as in is considered and the corresponding large-scale channel gains are generated for active users. A 1 MHz bandwidth and a noise power ranging from σ²=−90:−110 dBm is considered while the target received power and maximum transmit power ρ_{trg}=−90 dBm and ρₘₐₓ=23 dBm, respectively.

FIG. 6b illustrates mis-detection rate vs Noise power for co-located and distributed mMIMO with M=20, N=4, L=40. Referring to FIG. 6B, a multiple order performance improvement in terms of active user misdetection rate (Pₘᵢₛ) is observed by the proposed scheme. Moreover, Pₘᵢₛ for the proposed MAD system is shown to be only limited by residual interference while being invariant to additive noise opening opportunities for further optimization of system parameters such as P and adjacency matrix.

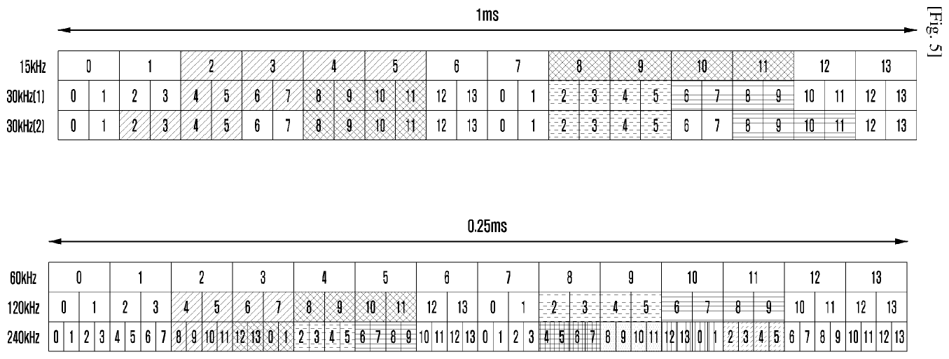

FIG. 7 illustrates an exemplary embodiment of the disclosure. Referring to FIG. 7, K users (703) transmit their uplink packets in a time-synchronized grant-free access manner. For synchronization purpose a downlink synchronization signal such as SSB (700) can be considered. A user after receiving a DL synchronization signal, transmits its packet in the next available transmission opportunity (time slot).

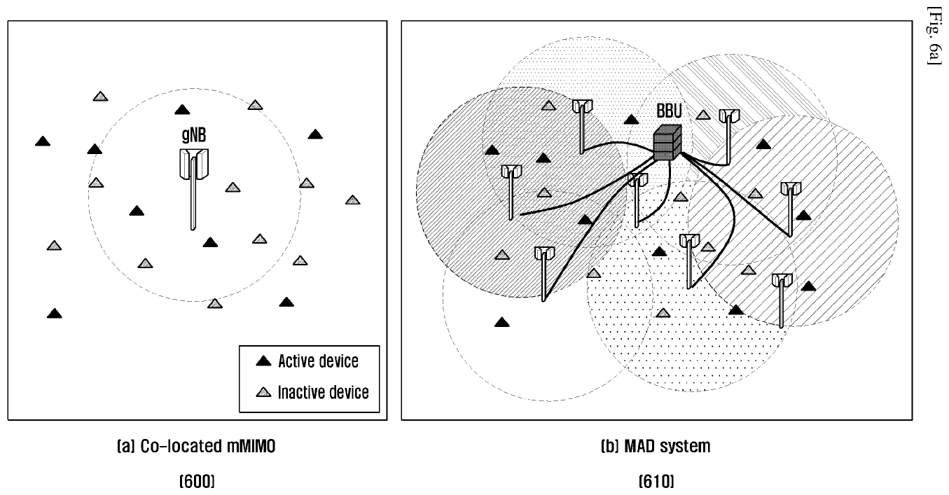

FIG. 8 illustrates an exemplary embodiment for a transmission structure according to the disclosure. A single transmission opportunity is depicted in 801, which is divided to a downlink synchronization and broadcasting subslot (803) and uplink packet (802). An uplink packet (802) is in turn divided into preamble (804) and data (805) parts. One exemplary application is a transmission of sensor measurements by networked sensors. The measurement data can be transmitted in the data part (805) of the uplink packet. The data part (805) can also include the ID of the device. If two or more users select the same preamble and if these transmissions are received at the same reception point, the multiple transmission points would collide and may not be differentiable.

FIG. 9 illustrates another exemplary embodiment of co-located mMIMO system and distributed mMIMO system according to the disclosure. Referring to FIG. 9, a co-located mMIMO system (900) and a distributed mMIMO system (901) are illustrated. Moreover, a collision domain for co-located mMIMO centered at the gNB (902) is illustrated by a hypothetical circle (904). In co-located mMIMO system (900), users which are located in the collision domain would collide if they select the same preamble. On the other hand, for a distributed mMIMO system in (b)(901), with proper power control introduced in this invention, multiple collision domains can be formed. A collision domains surrounding a radio remote heads (RRHs) (905, 906) are illustrated by the hypothetical circles (907, 908). As these collision domains are nonoverlapping, reception by the corresponding RRHs form users located in these two collision domains would not collide with each other even if the same preamble is selected.

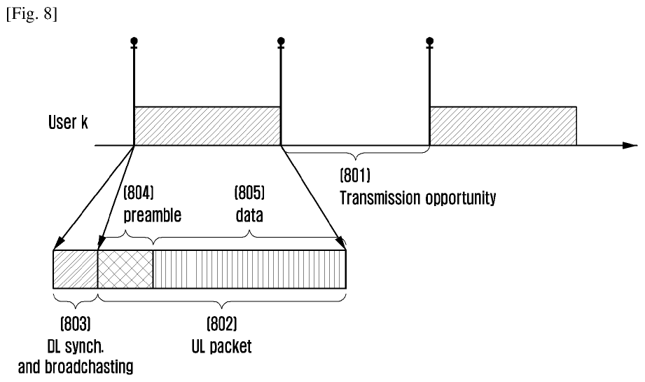

FIG. 10 illustrates the signaling between the network and a UE according to an embodiment of the disclosure. Referring to FIG. 10, the signaling exchange between the network (1000, or a base station, or a plurality of TRPs) and a UE (1001) is illustrated. The network (1000) transmits synchronization signals (SSBs) and indication of the value P and target power σ_{trg}² to a UE (1001) in step 1002. Each SSB in step 1002 corresponds to a TRP. The UE (1001) which receives the SSBs then estimates the downlink signal power including large-scale channel gains from each TRPs via corresponding SSBs in step 1003. The UE (1001) then controls its power according to Equation 5 in step 1005. The UE (1001) identifies uplink transmit power for transmitting a preamble and data to P-th strongest TRP. The active users are then detected at the network (1000) in step 1004. In one exemplary embodiment, at the network (1000), the N strongest active UEs are detected at each TRP. The parameters broadcasted by the network (1000), including P and target received power σ_{trg}² can be set by the network based on the QoS of devices, traffic load and other factors.

An exemplary Indication/configuration of the aforementioned parameters by the base station for different levels of QoS is provided in TABLE 1. In the table, the parameter P and target received power levels (dBm) are indicated for four different QoS levels.

In one exemplary embodiment, the parameter P and target received power (dBm) are indicated for plurality of QoS levels to the UE via system information block (SIB). This approach gives the network more degree-of-freedom to control access bearing for the different QoS levels.

In a yet another exemplary embodiment, the target received power (dBm) are prespecified for different QoS levels, and the parameter P for the plurality of QoS levels are indicated via SIB. This approach reduces signaling overhead to indicate the aforementioned parameters.

TABLE 1

| | | | Target received |
|---|---|---|---|
| Index | QoS level | Parameter P | power (dBm) |
| 1 | LEVEL-1 | P₁ | σ_{trg, 1}² |
| 2 | LEVEL-2 | P₂ | σ_{trg, 1}² |
| 3 | LEVEL-3 | P₃ | σ_{trg, 1}² |
| 4 | LEVEL-4 | P₄ | σ_{trg, 1}² |

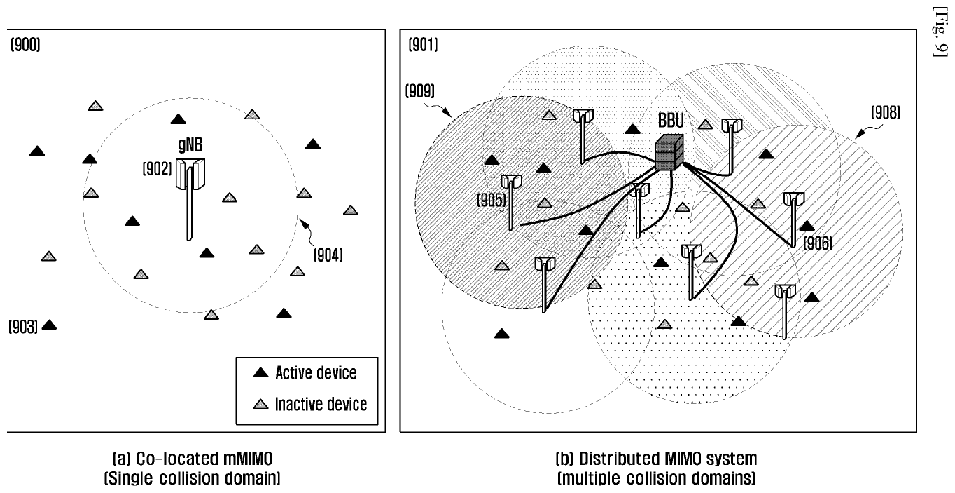

FIG. 11 illustrates a procedure of the UE according to an embodiment of the disclosure. Referring to FIG. 11, the procedure performed by the UE for receiving indication from the base station the aforementioned power control parameters and determine its transmit power is illustrated. The UE receives a plurality of SSBs, each of the plurality of SSBs corresponding to each of the TRPs, and measures received powers of the plurality of SSBs and sorts the received powers in descending order (1106). The signal received by the UE is not limited to the SSB, and may be various reference signals such as CSI-RS (channel state information reference signal) and DMRS (demodulation reference signal). The UE obtains a plurality of parameter combinations for power control for QoS levels by at least one of SIB, radio resource control layer signaling, or predefined parameter set (1107). Upon obtaining the aforementioned parameters, the UE identifies the parameters which corresponds to its preassigned or configured QoS level (1108). Then the UE performs the uplink power control by following the procedure above to the P-th strongest TRP (1109).

The following documents and standards descriptions are hereby incorporated into the present disclosure as if fully set forth herein:

### <Fresnel Zone Beam Forming>

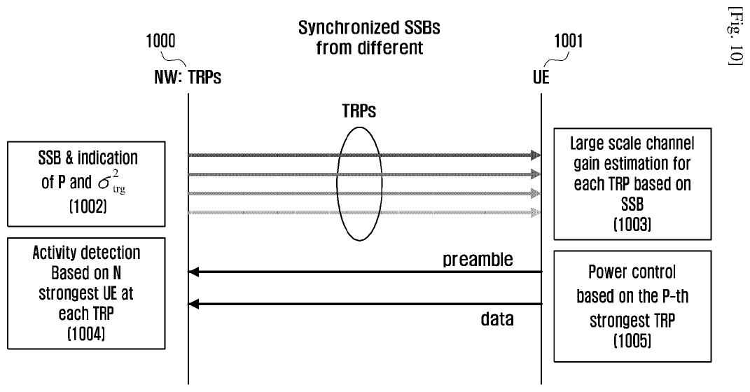

FIG. 12 illustrates an example of electromagnetic field in the vicinity of an antenna. The radiation of the electromagnetic field in the vicinity of an antenna (1200) can be divided in three difference zone [12]. These are Rayleigh zone (very near field) (1210), Fresnel Zone (near field) (1220), and Frauenhoffer Zone (far field) (1230) as shown in FIG. 12. Between near and far field, there is the arbitrary limit R₀, that is

$${R}_{0} = \frac{2 {D}^{2}}{λ} ,$$

where D is the length of aperture and λ is the wavelength.

In addition, another limit can be defined between very near field and Fresnel zone, that is

$$R = 0.62 {( \frac{{D}^{2}}{λ} )}^{1 / 2} .$$

Between R and R₀, called focal region, monotonous spherical waves are assumed so that free-space pathloss cannot be applied. Due to complex and inhomogeneous waves are propagated in this zone, even higher intensity can be observed than boundary of Frauenhoffer zone [2].

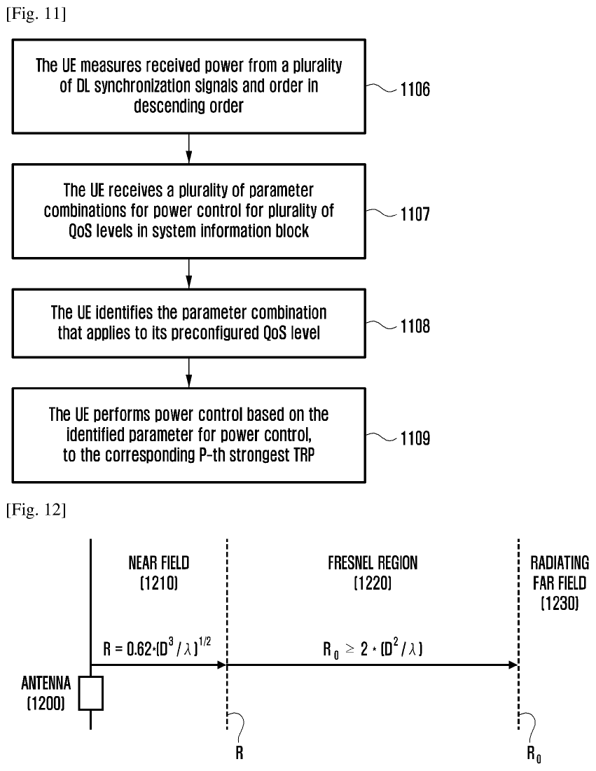

FIG. 13 illustrates an example of phase array antennas. Typical phase array antenna, as shown in FIG. 13, is designed to deliver signal in a specific direction

of far-field using antenna elements with equal spacing [13]. Referring to FIG. 13, (a) (1300) illustrates the conventional antenna array structure with 16×16 elements in the center, and (b) (1350) illustrates each of 8×8 sub-patch module is placed at the corner for large aperture (equivalent to the size of 50 elements in each dimension). In order to increase the aperture size (for higher gain), it is necessary to increase the number of antenna elements (1305), but operating massive elements increase complexity in either or both analog and digital domain at the transmitter. In order to make the wider aperture without increasing the number of antenna element, the entire elements are divide into sub-panels and placed in each corner ((b) (1350)). Even if elements are not existed in the middle (between sub-panels), the proposed structure effectively increases the aperture size. Note that if the distance between the antenna subpanels does not exceed 10 times of wavelength, spatial correlation is still existed.

The proposed Beamforming method is composed of two steps. The first step is the step of estimating the channel through the user's uplink sounding and estimating the propagation distance and direction from the transmitter. In case of indoor channel environment, since most of links have a line-of-sight (LOS), the receiver can estimate the distance dᵣ and angle θᵣ of the user. The next step is to obtain a beamforming weight. For this purpose, two cases are considered: one is the case where the UE is in the focal region and the other is outside the focal area. For each elements i, beamforming weight w(i) for focusing can be expressed as Equation 6.

$$w ( i ) = exp j \frac{2 π}{λ} \cdot D ( i ) * sin 2 π \cdot 4 \cdot V ( i ) \qquad [ Equation 6 ]$$

where

$$D ( i ) = {d}_{a} \cdot i \cdot ( cos {θ}_{r} \cdot tan 0.5 \cdot a tan \frac{{d}_{r}}{{d}_{a} \cdot i \cdot cos {θ}_{r}} - tan {θ}_{r} - sin {θ}_{r} ) , \\ V ( i ) = a cot ( \frac{{d}_{r}}{{d}_{a} \cdot i \cdot cos {θ}_{r}} - tan {θ}_{r} ) ,$$

dₐ is distance between elements. If users are not in focal region, by setting dr, as infinite, the Frauenhoffer beamforming weights can be obtained from Equation 6.

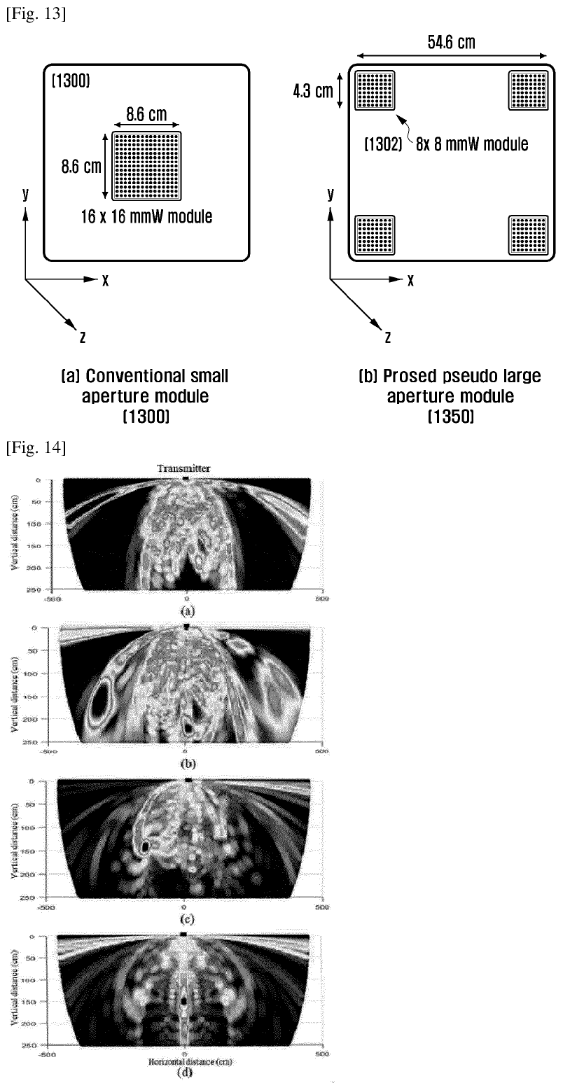

FIG. 14 illustrates the signal strength of proposed scheme for various angle (θᵣ=0°, −30°, −45°, −75°) and distance (dᵣ=1.5 m) according to the disclosure. In FIG. 14, (a) is the signal strength in case of θ=−75°, (b) is the signal strength in case of θ=−45°, (c) is the signal strength in case of θ=−30°, and (d) is the signal strength in case of θ=0°. The results show the signal strength field after applying the proposed beamforming method. For illustration simplicity, the signal strength of the two-dimensional space is shown from indoor space. From the results (d) and (c), users in the focal region, the proposed beamforming can strength the received signal power only for specific point. On the other hand, users outside of focal region, the focusing effect becomes increasingly reduced, such as in (a) and (b), and the beamforming effect is gradually reached Frauenhoffer zone beaming as user direction increases toward from the center.

Meanwhile, embodiments of the disclosure disclosed in the specifications and drawings are presented only for specific examples to easily describe technical content of the disclosure and help understanding of the disclosure, but do not limit the scope of the disclosure. That is, it is obvious to those skilled in the art to which the disclosure belongs that other modifications based on the technical idea of the disclosure can be achieved. Further, respective embodiments may be combined and realized as necessary. For example, the first embodiment and the second embodiment may be combined and applied. Further, embodiments of the disclosure may be applied to the LTE system and the 5G system through other modified examples based on the technical idea of the embodiments.

Although the disclosure is described with reference to embodiments, various changes and modifications may be proposed to those skilled in the art. The disclosure intends to include changes and modifications existing within the scope of the appended claims. Any of the detailed description of the document should not be read that a specific element, process, or function is a necessary element which should be included in the scope of the claims. Patented scope of the subject is defined by the claims.

Although the present disclosure has been described with various embodiments, various changes and modifications may be suggested to one skilled in the art. It is intended that the present disclosure encompass such changes and modifications as fall within the scope of the appended claims.

### REFERENCES

[1] RP-193133, New WID: Further enhancements on MIMO for NR, Samsung
[2] 3GPP TS 38.213, V15.12.0(2020-12): “NR; Physical layer procedures for control (Release 15)”,
[3] 3GPP TS 38.214, V15.11.0 (2020-09): “NR; Physical layer procedures for data (Release 15)”,
[4] 3GPP TS 38.213, V16.4.0 (2020-12): “NR; Physical layer procedures for control (Release 16)”
[5] 3GPP TS 38.214, V16.4.0 (2020-12): “NR; Physical layer procedures for data (Release 16)”,
[6] 3GPP TS 38.321, V16.3.0 (2020-12): “NR; Medium Access Control (MAC) protocol specification (Release 16)”,
[7] 3GPP TS 38.331, V16.3.1 (2021-01): “NR; Radio Resource Control (RRC) protocol specification
[8] 3GPP TS 38.211, V16.4.0 (2020-12): “NR; Physical channels and modulation.”
[9] 3GPP TS 38.212, V16.4.0 (2020-12): “NR; Multiplexing and channel coding.”
[10] 3GPP TS 38.215, V16.4.0 (2020-12): “NR; Physical layer measurements”
[11] J. Kibi³da et al., “Indoor Millimeter-Wave Systems: Design and Performance Evaluation,” in Proceedings of the IEEE, vol. 108, no. 6, pp. 923-944, June 2020, doi: 10.1109/JPROC.2020.2989189.
[12] Gillen, Glen D., and Shekhar Guha. “Modeling and propagation of near-field diffraction patterns: a more complete approach.” American journal of physics 72.9 (2004): 1195-1201.
[13] H. Chou and Z. Tsai, “Near-Field Focus Radiation of Multibeam Phased Array of Antennas Realized by Using Modified Rotman Lens Beamformer,” in IEEE Transactions on Antennas and Propagation, vol. 66, no. 12, pp. 6618-6628, December 2018, doi: 10.1109/TAP.2018.2874677.
[14] P. Li, S. Qu, S. Yang, Y. Liu and Q. Xue, “Near-Field Focused Array Antenna With Frequency-Tunable Focal Distance,” in IEEE Transactions on Antennas and Propagation, vol. 66, no. 7, pp. 3401-3410, July 2018, doi: 10.1109/TAP.2018.2826656.
[15] X. Chen, et al., “Massive Access for 5G and Beyond,” in IEEE Journal on Selected Areas in Communications, vol. 39, no. 3, pp. 615-637, March 2021.
[16] A. T. Abebe and C. G. Kang, “MIMO-Based Reliable Grant-Free Massive Access With QoS Differentiation for 5G and Beyond,” in IEEE Journal on Selected Areas in Communications, vol. 39, no. 3, pp. 773-787, March 2021.
[17] U. K. Ganesan, et al., “An Algorithm for Grant-Free Random Access in Cell-Free Massive MIMO,” 2020 IEEE 21st Int. Workshop on Signal Processing Advances in Wireless Communications (SPAWC), 2020, pp. 1-5.
[18] R. Gribonval, H. Rauhut, K. Schnass, and P. Vandergheynst “Atoms of all channels unite! Average case analysis of multi-channel sparse recovery using greedy algorithms”, J. Fourier Anal. Appl, vol. 14 no. 5 pp. 655-687 2008.
[19] WO2018222123—POWER CONTROL OF RANDOM ACCESS IN NB-IOT

1. A method performed by a terminal in a communication system, the method comprising:
receiving a plurality of signals from a plurality of transmission and reception points (TRPs), respectively;
obtaining each of a plurality of channel gains corresponding to each of the TRPs based on the received plurality of signals;
obtaining a parameter for identifying an uplink transmission power;
identifying the uplink transmission power for a TRP among the plurality of TRPs based on the parameter and a channel gain associated with the TRP; and
transmitting an uplink signal based on the identified uplink transmission power.

2. The method of claim 1, wherein the plurality of signals correspond to synchronization signal blocks (SSBs) from the plurality of TRPs respectively.

3. The method of claim 1, wherein the parameter is obtained based on a received system information block (SIB) or preconfigured information.

4. The method of claim 1, wherein the uplink transmission power for the TRP is identified based on a target receive power for the TRP obtained based on the parameter and the channel gain associated with the TRP.

5. The method of claim 4, wherein the parameter is associated with a quality of service or a traffic load.

6. A terminal in a communication system, the terminal comprising:
a transceiver; and
a controller coupled with the transceiver and configured to:
receive a plurality of signals from a plurality of transmission and reception points (TRPs), respectively,
obtain each of a plurality of channel gains corresponding to each of the TRPs based on the received plurality of signals,
obtain a parameter for identifying an uplink transmission power, identify the uplink transmission power for a TRP among the plurality of TRPs based on the parameter and a channel gain associated with the TRP, and
transmit an uplink signal based on the identified uplink transmission power.

7. The terminal of claim 1, wherein the plurality of signals correspond to synchronization signal blocks (SSBs) from the plurality of TRPs respectively.

8. The terminal of claim 1, wherein the parameter is obtained based on a received system information block (SIB) or preconfigured information.

9. The terminal of claim 1, wherein the uplink transmission power for the TRP is identified based on a target receive power for the TRP obtained based on the parameter and the channel gain associated with the TRP.

10. The terminal of claim 9, wherein the parameter is associated with a quality of service or a traffic load.

11. A method performed by a base station in a communication system, the method comprising:
transmitting, to a terminal, a plurality of signals corresponding to a plurality of transmission and reception points (TRPs), respectively;
transmitting, to the terminal, a parameter for identifying an uplink transmission power via system information block (SIB); and
receiving, from the terminal, an uplink signal for a TRP,
wherein the uplink signal is transmitted according to the uplink transmission power for the TRP associated with the parameter and a channel gain associated with the TRP.

12. The method of claim 11, wherein the plurality of signals correspond to synchronization signal blocks (SSBs) from the plurality of TRPs respectively.

13. A base station in a communication system, the base station comprising:
a transceiver; and
a controller coupled with the transceiver and configured to:
transmit, to a terminal, a plurality of signals corresponding to a plurality of transmission and reception points (TRPs), respectively, transmit, to the terminal, a parameter for identifying an uplink transmission power via system information block (SIB), and
receive, from the terminal, an uplink signal for a TRP,
wherein the uplink signal is transmitted according to the uplink transmission power for the TRP associated with the parameter and a channel gain associated with the TRP.

14. The base station of claim 13, wherein the plurality of signals correspond to synchronization signal blocks (SSBs) from the plurality of TRPs respectively.
